(19) United States
(12) Patent Application Publication
(10) Pub. No.: US 2020/0097919 A1
(43) Pub. Date: Mar. 26, 2020

(54) SERVER SUPPORTED MOBILE APPLICATION FOR SCHEDULING OR CONDUCTING TRANSACTIONS

(71) Applicant: Geoffrey R. Gehrke, Fremont, CA (US)

(72) Inventor: Geoffrey R. Gehrke, Fremont, CA (US)

(21) Appl. No.: 16/699,372

(22) Filed: Nov. 29, 2019

Related U.S. Application Data
(63) Continuation of application No. 15/053,850, filed on Feb. 25, 2016, now abandoned.
(60) Provisional application No. 62/120,730, filed on Feb. 25, 2015.

(51) Int. Cl. G06Q 10/10; H04W 4/18; G06Q 30/02

(52) U.S. Cl. CPC G06Q 10/1095; G06Q 30/0281; H04W 4/18

(57) ABSTRACT

The invention described herein is a system and method for easily connecting consumers seeking services with the provider of the services being sought, and for providing an easy and cost efficient method for scheduling those services. The system consists generally of a network connected service in communication with a database and various mobile communications devices such as smart phones, laptops and other mobile computing devices executing a mobile software application in non-transitory memory enabling service professionals to publish their calendars showing availability as well as location and service consumers to search for availability within a specifically desired time from and geographical location. The service consumer may input a time and date in which he/she wants to receive a requested service. The system searches the database to find service professionals providing the requested service who are available within the requested time frame and geographical locations sought by the service consumer, processes the available data to determine potential availability and location, providing display of available service providers including available time slots allowing service consumers to select preferences which are made available to the service provider to accept, deny or request modification. In this way the application allows for easy communication and transparency of scheduling between service providers (i.e. service professionals) and service consumers. The application provides for both service professional and service consumer side interfaces thus allowing an individual to both schedule the receipt of services from service professionals as well as schedule the provision of services to service consumers.

### CROSS-REFERENCE TO RELATED APPLICATIONS

The present non-provisional application is a continuation of US application serial number 15/053,850 filed Feb. 25, 2016 which claims the benefit of a commonly assigned provisional application having Ser. No. 62/120,730, filed on Feb. 25, 2015 and entitled Mobile Application Program, which application is incorporated herein by reference in its entirety.

### BACKGROUND OF THE INVENTION

### 1. Field of the Invention

The present invention is in the field of server-supported mobile software applications and pertains particularly to a mobile application that can be used for both provision and consumption of services over a network.

### 2. Discussion of the State of the Art

In the field of server-supported mobile computing, particularly service consumption and provision, there are one-sided network-based interfaces (typically a Website) that are made available typically through a service provider or a third party operating for the service provider that enable consumers to book appointments to receive services, make payments for received services and so on. There are also consumer-based applications (typically third-party applications) that help consumers look for qualified service providers including enabling consumers to rate their experiences with a particular service provider. That is to say simply that service providers can publish their availability and book their clients while consumers may search for an entity who provides a service, view a service provider's calendar availability and book appointments with the service provider of their choice.

There are several challenges for service providers and for consumers, each using separate applications in order to communicate and to interact with one another. For example, individuals who may provide network-accessible services often expend too much time attempting to communicate with and to set and manage appointments with their clients in an economically efficient manner. Existing interfaces are largely Web-based interfaces for service providers where consumers have separate native application such as Yelp for locating service providers, at which time the consumer may have to “navigate” to the select provider's native Website to schedule services. Many provider interfaces require the consumer to be accessing from a computing appliance during working hours of the service provider. Other challenges exist relative to requirements of more than one application or interface required to conduct business in an efficient manner. For example, a service provider who is also a consumer may be required to use separate applications or tools when providing a service and when consuming a service.

Therefore, what is clearly needed is a single mobile application that may be used by both service providers and consumers to interact with clients and to consume services respectively.

### BRIEF SUMMARY OF THE INVENTION

The invention described herein is a system and method for easily connecting consumers seeking services with the provider of the services being sought, and for providing an easy and cost efficient method for scheduling those services. The system consists generally of a network connected service in communication with a database and various mobile communications devices (including smart phones, laptops and other mobile computing devices having calendars and search function to depict the month, day and time of day) executing a software application in non-transitory memory. The software application allows a user who seeks any service (referred to herein as a service consumer) to easily find and schedule appointments for service with a user who provides any service (referred to herein as a service professional). The application enables service professionals to publish their calendars showing availability as well as location and service consumers to search for availability within a specifically desired time from and geographical location. The service consumer may input a time and date in which he/she wants to receive a specific type of service. The system searches the database to find service professionals providing the requested service who are available within the requested time frame and geographical location(s) sought by the service consumer, processes the available data to determine potential availability, including calculations of geographical location and travel times, and provides a display of potentially available service providers including available time slots. The service consumer then makes a selection of available time slots and that request is made available to the service provider who may accept the proposed appointment, deny it or provide alternative times and locations for scheduling. In this way the application allows for easy communication and transparency of scheduling between service providers (i.e. service professionals) and service consumers. The application provides for both service professional and service consumer side interfaces thus allowing an individual to both schedule the receipt of services from service professionals as well as schedule the provision of services to service consumers.

The system includes a server, database, network, and mobile application operating on a plurality of mobile computerized communication devices (including handheld devices such as smartphones and tablets) enabling calendars with search functions for month, day and time of day, and enabling a global positioning system (GPS). The mobile application includes a first interface for a service professional enabling registration and description of services provided including profile data as well as a second interface provided by the mobile application for a service consumer enabling set up of profile data. The mobile application enables dynamic switching between the first and second interface; the mobile application further including a first calendar displayable in the first interface and a second calendar displayable in the second interface, wherein the service provider enters available dates and times for providing services in the first calendar and the service consumer enters available dates and times for receiving services in the second calendar; and a search function screen in the second interface enabling the consumer to enter a search request for a type of service or service provider, a geographic radius threshold from the service consumer's location and a service date or date range; and wherein the registration, profile and calendar data are received by the server and stored in the database and in response to receiving the search request the server accesses the available dates and times for providing services in the first calendar, matching the search request, generating a list of service providers having availability according to the date or date range entered in the search request and a location within the geographic threshold.

The invention includes a method for connecting service professionals (i.e. persons providing services) with service consumers (i.e. persons seeking services) including the steps of

(a) providing a first interface enabling a service provider to input services available and profile data via a first mobile computerized communication device at a first location of a service professional, via a mobile application stored on and executing from said device, said mobile application associated and communicating with the software over the network, the server storing the input to a database accessible to the server;

(b) providing a second interface via the mobile application stored on and executing from a second mobile computerized communication device at a second location of a service consumer enabling the service consumer to input profile data, the server storing the profile data to a database accessible to the server;

(c) providing a Global Positioning Service (GPS) on the first and second computerized communication devices enabled to communicate with the software at the server via the mobile application;

(d) providing a first calendar in the first interface enabling a service provider to enter dates and times available for providing services and a second calendar at the second interface enabling the service consumer to enter dates available for receiving services, said first calendar stored in the database;

(e) performing a search request by the service consumer at the second interface, the service request including service type, date, time and a geographic radius threshold from a location of the service consumer; and

(f) matching the search request to service providers by accessing available times and dates in the first calendar, services available and profile data as entered at the first interface and generating a list of selectable matched service providers to the second interface.

### BRIEF DESCRIPTION OF THE SEVERAL VIEWS OF THE DRAWINGS

FIG. 1 is an architectural overview of a communications network supporting service provision and consummation of services from a mobile platform according to an embodiment of the present invention.

FIG. 2 is a block diagram depicting main screen architecture of mobile application 110 of FIG. 1.

FIG. 3 is a process flow chart depicting steps for acquiring an appointment with a service provider through application 110 of FIG. 1 according to an embodiment of the present invention.

FIG. 4 is a process flow chart depicting steps for setting a correct screen for a user operating through application 110 of FIG. 1.

FIG. 5 is a process flow chart depicting steps for adding and managing one or more services through application 110.

FIG. 6 is a process flow chart 600 depicting steps for deriving mutually open calendar dates and times between a consumer's calendar and a service provider's calendar according to an embodiment of the present invention.

### DETAILED DESCRIPTION OF THE INVENTION

In various embodiments described in enabling detail herein, the inventor provides a dual-mode, mobile application that efficiently facilitates trade between service professionals and consumers. In one mode the application provides service professionals with a complete, business-in-a-box system to handle all aspects of running a service-related business, including advertising, scheduling, client engagement, accounting and payment processing. In the other mode the application provides consumers an easy-to-use system in which to schedule and purchase services from professionals who meet specified search criteria including quality, cost, availability and geographical proximity.

The inventor provides a mobile software application supported by a server that enables a single user to function as a service provider and as a consumer of a service through a single interface. The present invention is described in enabling detail using the following examples, which may describe more than one relevant embodiment falling within the scope of the present invention.

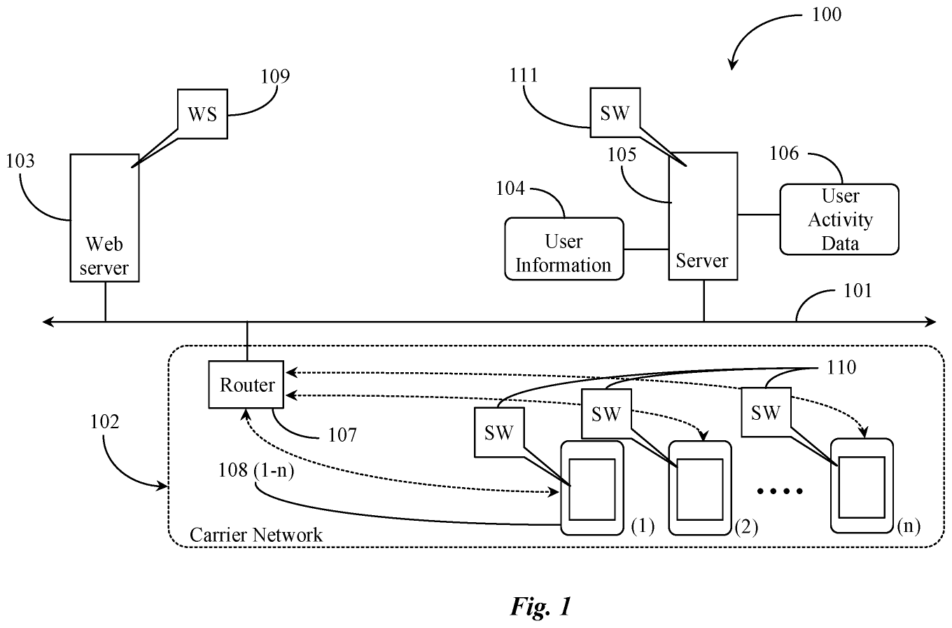

FIG. 1 is an architectural overview of a communications network 100 supporting service provision and consumption of services from a mobile platform according to an embodiment of the present invention. Communication network 100 includes a data network depicted herein as network backbone 101. Network backbone 101 may be referred to hereinafter as data network 101 and includes all of the lines, equipment, and access points that make up the data network including any connected sub-networks. Therefore, there are no particular geographic limitations to the practice of the present invention.

In this example, a sub-network 102 is depicted connected to data network 101 through an edge router or hub 107. Sub-network 102 may be a wireless cellular carrier telephony network, a wireless fidelity network (Wi-Fi), or another data carrier network. Network 102 includes a group of users operating mobile communication devices 108 (1-n). Devices 108 (1-n) are mobile communication devices including smart phones and tablets such as Android devices, smart phones, iPhones, iPads, or any other wireless commuting appliance or device capable of accessing a server on a data network and sync with the server. Devices 108 (1-n) have calendaring and search functions to depict month, day, and time of day.

Data network 101 may, in one embodiment, support a server 105 adapted to receive data from and send data to other devices over its network. Server 105 may be hosted and maintained by a provider of mobile application 110, depicted on and executable from communication devices 108 (1-n) or by a third-party entity providing server space without departing from the spirit and scope of the present invention. Mobile application 110 may be purchased from an application store as a “business in a box solution”. Server 105 hosts a software application 111 for brokering data communication between users operating mobile communications devices 108 (1-n) that engage in interaction with one another.

In one embodiment, data server 105 may be an Internet-connected server. In such an embodiment, there may be a separate Web server, illustrated herein as Web server 103, that may provide via a Web site (WS) 109 access to server 105 “by proxy”. Website 109 may represent in one implementation a network-based contact or access point to enable users who may not yet have the software from an application store on their devices to acquire the mobile application in a download from the Website to begin practice of the invention. In some embodiments, the Website 109 may be a web application store or provider (such as Apple or Google application stores). It is noted herein that a Web server and Website are not required to practice the invention.

Mobile application (SW) 110 may be referred to hereinafter as simply SW 110. SW 110 is an executable mobile application, which enables a user to operate as a service provider providing one or more services to other users and as a service consumer consuming one or more services provided by other users through a same graphical user interface.

SW 110 may be installed on or downloaded to devices 108 (1-n) from memory or from a server. In one embodiment registration may be required to activate the software from a mobile device. In one embodiment registering of services is part of the SW application and can be initiated “off line” after download and execution of the application from any of devices 108 (1-n). To activate SW 110 a user must connect with server 105 to submit the required data.

SW 110 installed on mobile device 108 (1-n) may coordinate with SW application 111 hosted on data server 105 when looking for a service to engage or when the user is providing a service to a client operated by a provider of the service of the invention. Data server 105 is adapted to store and maintain personal and business information provided by the operators of devices 108 (1-n) and may include a customer information system (CIS) depicted as a database application in a data repository 104 connected to server 105. CIS data may include user identity, registration and authentication data, billing histories, profile status information, and other demographics about registered users.

In a preferred implementation, data server 105 is a “dedicated” server that via SW 111 may be adapted to support “directed” data syncing between users (service consumers, service providers) who are interacting while operating from their personal devices through mobile application 110. Server 105 includes a data repository 106 containing user activity data. User activity data may include scheduling or booking appointments (including month, day and time of day as well as location data), records of consumer choices relative to “select” service providers (other users) and purchases or transactions conducted with those service providers and service provider records detailing consumer activity of clients (other users).

SW application 110 has two main interfaces for users, namely a consumer home interface (screen) and a service provider interface (screen). It is noted herein that the screens are native to the mobile application and data input may arrive from server 105 or may be put in manually by the owner of the personal device. Server 105 serves or pushes data to the native screens. However, in one implementation server 105 may serve a screen such as an updated screen to replace another screen on the mobile application.

Application 110 enables operators of devices 108 (1-n) to actively consume services and actively provide services using only the mobile application to navigate between the two interfaces, thus providing a “two-sided” mobile application for fulfilling both activities (service provision, service consumption). In this way, any user that registers for the service and installs the mobile application may represent as a service provider or a consumer of services having all of the required tools to completely operate as both. SW 110 includes one or more “smart” algorithmic routines that make operating through the application convenient and expeditious whether the operator is functioning as a service provider or as a consumer of services.

In general use of the present invention, users operating devices 108 (1-n) may access data server 105 to register “activate” their mobile application with the service of the invention. In one implementation the user may through the application begin the process of activating the SW. During the process of activating the SW the user may for service may provide some initial information such as a user name and password and then begin configuring a service or looking for a service to engage. User information such as account information and the like may be stored in a data repository 104 on data server 105 (user information).

Once the user activates SW 110 via a server-detected action made by the user, server 105 aided by SW 111 may direct a first synchronization between the user's personal device and the server. The user may thereafter update status and make other changes while operating the mobile application online for changes to take effect immediately or offline and later connecting to the server through the application and sync with server 105. SW 111 may record all activity data and any updates to customer information in the respective data repositories while the user is connected with server 105. In this example activity of the users is stored in repository 106 (user activity data).

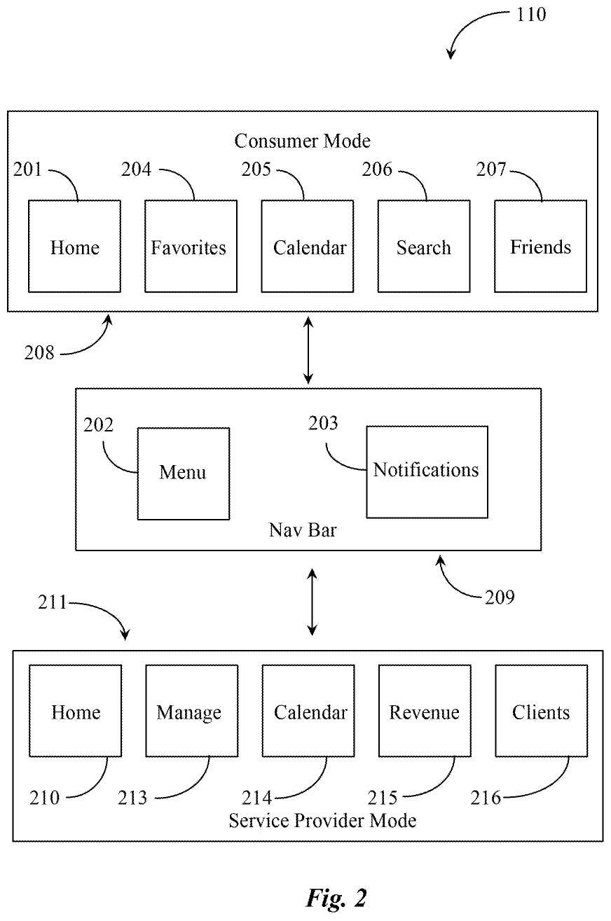

FIG. 2 is a block diagram depicting basic screen architecture of mobile application 110 of FIG. 1. Mobile application 110 includes a consumer mode 208 that provides access to all of the main screens and subsequent linked (Child) screens that enable a consumer of services to search for and select one or more services and schedule contact or appointment with the selected service provider or providers. Mobile application 110 also includes a service provider mode 211 that contains all of the main screens and subsequent linked (Child) screens that enable a provider of one or more services to market them and to fully service clients, including point-of-sale (POS) services like transaction recording, payment processing, revenue accounting, debit accounting and scheduling management. Each interface (consumer, service provider) has a navigation bar 209. Navigation bar 209 provides access to a menu 202 and a notifications screen 203. Navigation bar 209 may be accessible from all of the main screens by including the bar link on all of the screens so the user may navigate back from an accessed screen.

Consumer mode 208 contains a consumer home screen 201. Consumer home screen 201 may be presented to a user who is a consumer by default or through menu screen 202 until the user becomes a service provider and registers one or more services with the system. In one implementation application 110 takes the information (service provider or consumer or both) from the user during sign up. Once a user adds a service and registers as a service provider, a service provider home screen 210 may become accessible through navigation bar 209 and menu 202. It is noted herein that an operator using mobile application 110 may access a menu 202 and change screens between consumer mode and service provider mode of the application. Menu 202 may be accessible from a portion of or from all screens in both modes.

Navigation bar 209 includes a notification screen 203. Presence of notifications may be indicated on notifications screen 203 or alternatively in the navigation bar at the notifications icon (badge) showing the notifications that are present. In one implementation a portion or all of the screens include a notification link or window. Notification screen 203 may provide notification details. Notifications may include those from service providers responding to consumer requests, consumers responding to service providers, system notification, etc. Menu screen 202 may depict in iconic form or list form all of the other options including and or apart from the main tabs or screens. In a preferred implementation mode swapping is performed from the menu screen in either mode. Menu screen 202 is depicted in navigation bar 209.

Consumer mode 208 may include a favorites screen 204 that presents a list of favorite service providers of the consumer. Favorites screen 204 may include service provider summary screens of the favorite service providers of a particular consumer. Consumer mode 208 may include a consumer calendar screen 205 that depicts the consumer's schedule including the user's service events and any imported calendar events from the user's mobile device in Month, and Day and Time of Day views. Consumer mode 208 may include a search screen 206 adapted to enable a consumer to execute a search of available service providers within a particular geographic radius from the consumer.

GPS coordinates from a user's personal device are reported to the system so that the system may return search results back to a consumer that are limited to those providers that are found within a particular geographic radius from the user at the time of the request. The geographic radius may be adjustable in one implementation. A default maximum radius set by the system may be approximately 25 miles, however a user may adjust the maximum range higher or lower, or remove GPS restrictions altogether without departing from the spirit and scope of the present invention. In one implementation, the search screen may be used to search friends 207, favorites 204, and calendar events 205. In another implementation, separate search functions may be provided for searching items that are not services. In still another implementation no additional search functions are provided other than browsing or searching for services.

Service provider mode 211 contains a service provider home screen 210. Service provider home screen 210 may be presented to a user and may be useable when the user becomes a service provider and registers one or more services with the system. In one implementation the application takes the information from the user during sign up. It is noted herein that an operator (user) using mobile application 110 may access menu 202 and manually switch between consumer mode 208 and service provider mode 211 of the application. Menu 202 may be accessible from a portion of or all screens in both modes.

Service provider mode 211 includes screens having navigation bar 209 to access menu 202 and notifications 203. Presence of notifications may be indicated on service provider home screen 210 or alternatively in the navigation bar at the notifications icon (badge). In one implementation a portion or all of the screens include a navigation bar or window. Notification screen 202 may provide notification details. Notifications may include those from service providers responding to consumer requests, consumers responding to service providers, system notification, etc. Menu screen 202 may depict in iconic form or list form all of the other options apart from the main tabs or screens.

Service provider mode 211 may include a link to a service management screen 213. Service management screen 213 enables a service provider to manage provided services, activate or deactivate services, publish new services, etc. In one implementation, service management screen 213 may include one or more links to an advertisement utility for promoting listed services. In another implementation advertising options are integrated in the registration process. Service provider mode 211 may a client screen 216 that provides a list of all of the clients patronizing a service or services provided. In one implementation clients screen 216 is organized under the services that the operator has registered in the system if more than one.

Service provider mode 211 may include a revenue screen 215 that enables the service provider to conduct business as a POS terminal including transaction management, revenue accounting, and like status for each of the services provided. Service provider mode 211 contains a calendar screen 214. Calendar screen 214 may include the service provider's schedule in Month and Day view. It is noted herein that Calendar screens 205 and 214 for a single operator who is both a consumer and a service provider may depict a complete schedule for both consumer and service provider events. Scheduled events may also include personal events of the operator. In one implementation a service provider's calendar includes other events not related to service provision where the service provider would be unavailable. In one implementation where a service provider calendar includes personal events, certain classified events may not be viewable to the public in the calendar but may indicate simply that the person is unavailable for certain dates and times.

It is noted herein that consumer mode 208 and service provider mode 211 depicted herein may include other screens and utilities or tools not illustrated in this view without departing from the spirit and scope of the present invention. Menu 202 may contain a link to the consumer's account settings that provides further links to the consumer's profile, a help desk, privacy settings, terms of service, etc. Menu 202 in navigation bar 209 may also include links to a mail box, and a tutorial screen or presentation. Service provider home screen 210 may also include links to account settings, a mail box, a tutorial, etc. without departing from the spirit and scope of the present invention.

It is also noted herein that consumer and service provider home screens and at least a portion if not all of subsequent linked screens may include a navigation bar and a tab bar relative to the user mode that is active. It is noted herein that all changes and updates made offline in either mode are synced with the server periodically (initiated by the server). The GUI may be programmed using Swift, Objective C for the iOS platform or Java for the Android platform. In one implementation, Swift is the preferred programming language.

In one implementation when a user changes screens certain animations are incorporated such as one screen dissolving while being replaced by another screen. An operator may also implement touch screen actions to change views such as swiping from left to right or from right to left. In a preferred embodiment touch screen functionality is programmed into the mobile application as most all personal devices may be operated via touch screen input. It is noted herein that the programming language is not limited to only Objective C and Java languages, for example Swift is a new alternative programming language for the iOS platform that could be used to program the GUI.

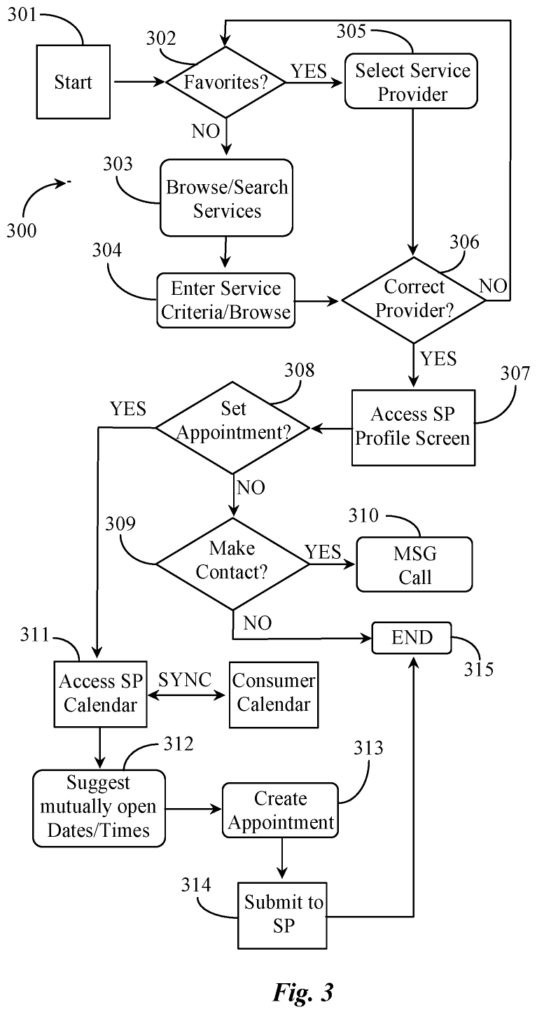

FIG. 3 is a process flow chart 300 depicting steps for acquiring an appointment with a service provider through application 110 of FIG. 1 according to an embodiment of the present invention. At step 301, the user may connect to the data server through the mobile application. Once on the consumer home screen, the user may first determine at step 302 if the service provider they want to contact is already known and listed in the consumer “Favorites” screen or list.

If the service provider is listed in favorites of the consumer at step 302, the process may skip over to step 305 where the user may select the service provider from the list. At step 306, the user may determine or validate whether the service provider selected is the correct provider. Validation of the selection may, in one implementation, be requested of the user by the application during navigation. If at step 306, the selected service provider was not the correct provider, the process may resolve back to step 302.

At step 302 if the desired service provider is not listed in favorites of the consumer, the consumer may browse for or search for applicable service providers at step 303 by clicking on a search link that open up a search utility screen such as screen 206 of FIG. 2. It is noted herein that the mobile application may display listed data comprising interaction links that a user may vertically or horizontally scroll through.

At step 304, the user may enter search criteria for the desired service or may browse listed services known to the service. It is noted herein that search results may be culled by geographic distance from the user at the time of the operation, for example, returning a list of providers located within a twenty-five-mile radius of the user as deduced through GPS reporting services standard to the user's personal device. Search criteria may include a service provider type, a service provider name.

At step 306 the user may determine if a correct service provider is found. A correct service provider may be one the user had in mind before launching a search or one that the user simply accepts from the results. In one aspect the user may simply select a suitable service provider from a provided list. It is noted herein that search results and browsed listings at the server are interactive so the user may look at a service description, location, etc. before making a determination as to whether the service provider is a correct provider at step 306.

Assuming it is the correct provider (the one the user wishes to contact), the user may access the service provider's service profile screen at step 307 for the purpose of furthering interaction with the provider. In one implementation, service provider results may also include meta-data such as average pricing range for services, average time before a service is fulfilled, user ratings information, and so on the user may see to help make a decision before actually accessing the provider screen. All service providers that may be found through search and or browsing are registered with the service as providers of one or more service.

At step 308, the consumer may determine whether to set an appointment with the service provider. If the consumer does not want an appointment with the provider at step 308, the consumer may determine whether to make contact with the provider at step 309. If the user determines not to contact the service provider at step 309, the process may end at step 315. In one implementation a user may bookmark or save the service provider screens to Favorites before the process ends for that search. The consumer may also refine search terms, and search multiple times before accepting a search provider. A consumer may also browse different service provider results and may access more than one service provider page before determining a correct service provider.

If the consumer determines to make contact with the service provider at step 309, the consumer may generate and send a message, or may place a call to the service provider entity at step 310. The mobile application may send all data first to the central server before it is forwarded to the service providers page by the server. The same may be true for contact initiated by a service provider, that is all activity including message text may first go to the server before it is forwarded to the consumer. The process may then resolve to step 315 and ends for that search task at step 315. Referring now back to step 308, if the consumer determines to set an appointment with the service provider, the consumer may access the service provider's calendar at step 311. It is noted herein that service provider data is registered with the service of the invention so that it is always available whether the service provider is actively managing the service or not. In one implementation a user may see in the search results an indication of whether or not a service provider listed in the results is active or not.

It is noted herein that all of the service provider's accessible screens are programmed in the same way as all of the consumer screens and therefore are subject to algorithmic manipulation by the system such as running a routine to “merge” calendars to see mutually open dates. In one implementation the service provider's calendar data occupies a screen in the consumer's mobile application and may be displayed adjacent to the consumer's calendar in a “spilt screen” format that shows physically all of the mutually open calendar dates and times.

At step 311, the accessed calendar of the service provider may be compared with a copy of the current the consumer calendar stored locally on the consumer device. The mobile application may suggest mutually open appointment dates and times to the user. This process may occur automatically and by default. At step 313, the consumer may create an appointment with the service provider at step 313. The consumer may send or submit the created appointment to the service provider at step 314. The process may then end at step 315.

It may be noted herein that the appointment request may be sent to the service provider as a notification, an email request, or other message and that the service provider may accept or decline the appointment. It is noted herein as well that the service provider may make proposed changes to a receive appointment request notification. In either case of declination, acceptance or request for revision, the consumer will receive a notification in their mailbox and on the consumer calendar in the mobile application stating the response of the service provider.

If the service provider determines to respond with a revision request such as shorten the appointment time or move to another mutually open slot, the service provider may be presented with the appointment request details page on the mobile application (110) of the service provider where the service provider can make amendments to the appointment request. Once the changes have been made, the service provider may confirm the changes by tapping a submission or confirmation icon to effect send of the revised request appointment data to the server. The new appointment data may be served to the consumer's device from the server provided the client agrees. The consumer may receive notification in their mailbox or in box in the consumer's mobile application, and in the consumer's calendar.

In one implementation some negotiation may ensue between a service provider and consumer exchange via request notification revision and resend. Revision surrounding an appointment request may continue until an appointment request is agreed upon (confirmed) or is canceled by either party. All activity between the consumer and the service provider is recorded and it may be that the consumer may wait a period before the service provider responds. The server may push notifications to users over the cellular network updating the consumer through the local application with the latest updates including confirmation of appointments and or counter requests sent by the service provider requesting, for example a different date and or time.

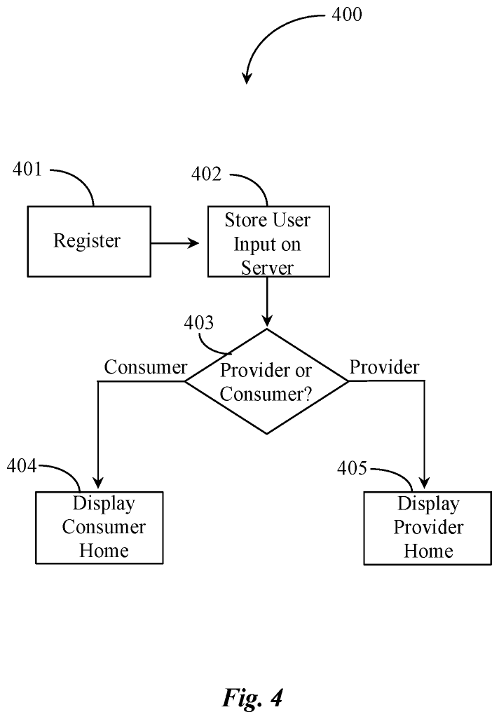

FIG. 4 is a process flow chart 400 depicting example embodiment of steps for setting a correct screen for a user operating through application 110 of FIG. 1. In this basic process, a user may register and log into the service through the native mobile application at step 401. All of the input provided by the user may be stored at the server in step 402. At step 403 the service may determine whether the user is a service provider or not. If the server determines that the user is not a service provider at step 403, the mobile application displays the consumer home screen by default at step 404 or, alternatively, the mobile application will display the consumer navigation bar at step 404. If it is determined that the user is a service provider based on the information known to the system, the mobile application will default to the service provider home screen 405 or, alternatively, the mobile application will display the service provider navigation bar. The mobile application default settings related to whether the service provider screen will be served or whether the consumer home screen will be served may be changed by a user, for example, a service provider who has an inactive service may set the default screen to consumer home screen. One with skill in the art of server-supported mobile SW applications will appreciate that the mobile application may synchronize with the data server when the data server has new data for the mobile application. Periodically, the server pushes the data to the application.

In an alternative embodiment, the user self-selects the mode in which he/she intends to use the application as either a service professional (or provider) or as a service consumer. The user accessed the application and, using the menu, navigates to the tab bar which includes operations relative to providing services (i.e. the service professional mode) or operations relative to receiving services (i.e. the service consumer mode).

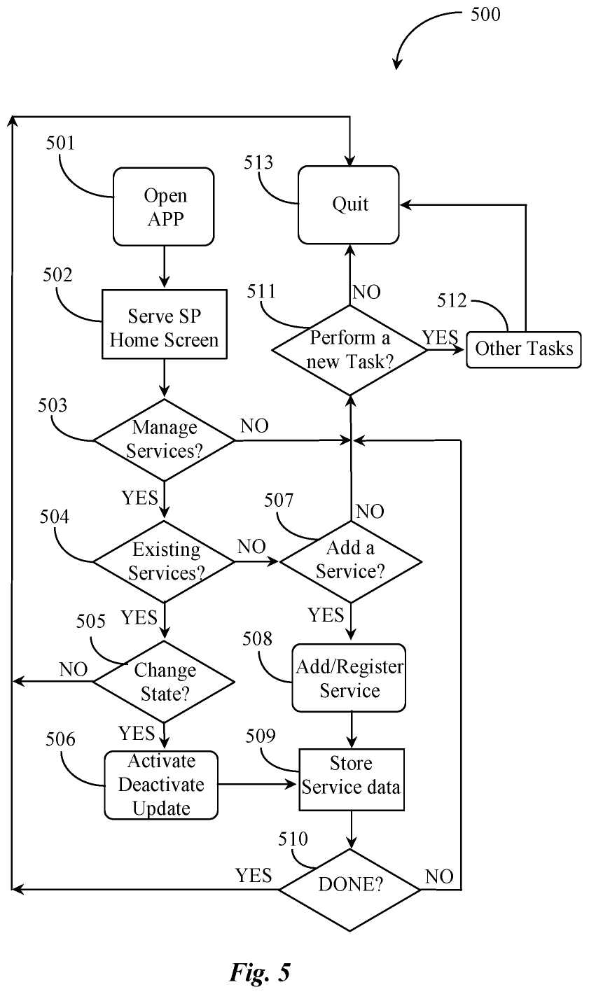

FIG. 5 is a process flow chart 500 depicting steps for adding and managing one or more services through application 110. It is assumed in this example that the user is a service provider at step 501 has a connection path to the data server. At step 502 the mobile application displays the service provider home screen. At step 503, the user may determine whether to manage an existing service or services. If the user determines not to manage or update any service at step 503, the process may skip to step 511 where the user may determine whether to perform another task. If the user determines at step 511 not to perform any other task, the user may quit at step 513.

If the user determines to perform another task at step 511, the process may move to step 512 where the user may initiate the desired task. After performing the desired task, the user may quit at step 513, or in one aspect, may determine to perform yet another task in which case, the process would loop back to step 511.

At step 503 if it is determined to manage one or more services, the user may next determine whether they will manage or update an existing service or services at step 504. If the user determines at step 504 to manage or update an existing service, the user may determine whether or not to change the active state of the service or services. If the user determines not to change the active state of the service, the process may resolve back to step 513 where the user may quit. If the user decides to change the state of a service at step 505, the user may activate or deactivate a service or services at step 506. The state changes are sent to the data server from the local application and stored at the server in step 509. It is noted herein that the user may also decide to update an existing service at step 505 rather than changing the state (active, inactive) of the service. In this case, the user may perform one or more updates at step 506 and the mobile application may sync the input data at step 509.

At step 510, the user may determine whether or not the user is finished or done working in the application. If the user is done at step 510, the process may resolve to step 511, 512, and eventually 513. Back at step 504 if the user determines not to manage an existing service, the user may determine whether or not to add a service at step 507. If the user does not desire to add a new service at step 507 the process may resolve to step 511, 512, and 513.

If the user determines to add a new service or services at step 507, the user may manually add and register them at step 508. In adding a service, the user may provide a number of information blocks such as service type, service description, service pricing structure, contact information, etc. for each added service. All data input by the user is synced with the server at step 509. After the input data is stored on the server the user may determine if he or she is done managing services at step 510. If so, the user may quit at step 513. If the user is not finished working in the application the process may resolve back to step 511, 512, and 513.

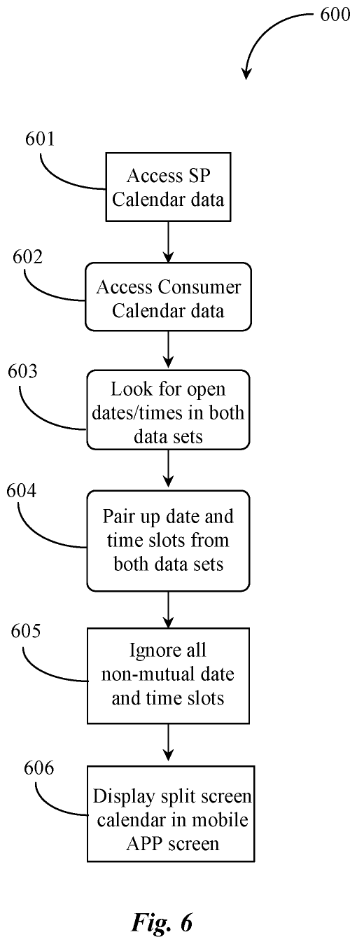

FIG. 6 is a process flow chart 600 depicting steps for deriving mutually open calendar dates and times between a consumer's calendar and a service provider's calendar according to an embodiment of the present invention. It is assumed in this process that the user is a consumer and is attempting to book an appointment with a select service provider. At step 601, the mobile application accesses the service provider's calendar schedule from the server.

At step 602, the mobile application accesses the consumer calendar data stored locally on the personal device of the consumer. The amount of time represented by the consumer calendar data may be the same as for the service provider calendar data. At step 603, the mobile application executes an algorithm that searches for open dates and times in both sets of calendar data for the entire period of time the data represents. Because both the consumer and the service provider are registered with the service of the invention the calendar data and formats are consistent with one another. An algorithm may also include a process for displaying two calendars side by side in the user's mobile application screen or a “split screen”. In this case the user may also manually look at mutually open dates in normal calendar format and select a date and time.

At step 604, the mobile application may “pair up” date and time slots from both calendar data sets. In this step the algorithm flags pairs that have an entry from both calendar sets representing mutually open date and time slots. At step 605, the algorithm may ignore data showing “unavailable” dates and times so that the user only has to look at mutually available dates and time. Rules may be provided that define time slots for an appointment. In one embodiment the service provider may determine what time frames constitute a block of time for conducting an appointment.

Furthermore, a service provider may impose different time blocks or time frames for appointments relative to different service operations for which a consumer may request. For example, an appointment to inspect a roof may require a three-hour time block including buffer time for transportation etc. Whereas an appointment to close a previously discussed contract to roof the home may only require one and one half hours or half the time. The mobile application may discern the constraints used in the service provider data and apply the same restrictions or constraints to the consumer's calendar. In this way the service provider may improve the economics of servicing the clients by conducting appointments more efficiently regarding allotted time for services. Other types of services may not call for such constraints and there may be other governing constraints without departing from the spirit and scope of the present invention.

At step 606 the mobile application may display a screen to the consumer displaying a list of dates and times that both the consumer and the service provider are free to interact. The consumer may then select a time block and request the appointment as described further above with respect to process 300 of FIG. 3. In one implementation, the mobile application may make a selection for the user or may suggest a particular time slot and date based on some other intelligence. For example, the mobile application may look at time between booked appointments for a user and select or suggest a block of time and a date that is fairly evenly spaced with other bookings on the consumer calendar so as to not over commit the user by having too many bookings too close together.

It will be apparent to one with skill in the art that the dual mode mobile application and interaction system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will also be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims.

1. A system for connecting service professionals providing services with service consumers of said services, comprising;
server connected to a network capable of data communication, storing and executing software enabling communication with mobile communication devices and mobile applications executing thereon;
a database accessible to the server;
a first computerized communication device at a first location of a service professional storing and executing a mobile application from a non-transitory memory, said mobile application providing a first display, and communicating with the software over the network;
a second computerized communication device at a second location of the service consumer storing and executing the mobile application from a non-transitory memory, the mobile application providing a second display;
a first interface presented in the first display enabled to at least display a first calendar generated by the mobile application, the service professional marking blocked dates and dates open for service in the first calendar;
a second interface provided by the mobile application for a service consumer providing at least a search function screen;
wherein the first computerized communication device includes a second locally stored calendar for the professional, third party to the mobile application, and the second computerized communication device includes a third locally stored calendar for the service consumer, third party to the mobile application, the mobile application enables dynamic switching between the first and second interface in each of the first and second displays enabling the professional to also function as a service consumer in the first display and the service consumer to also function as a service professional in the second display, and;
the search function screen in the second interface enables the service consumer to enter a search request for a type of service or service provider, and a service date or date range; and
wherein as a result of the search request,-the server accesses available dates and times for providing services in the first calendar, matching the search request, generating a list of service providers, upon selection of a service provider by the service consumer, data from the second calendar is merged into the first calendar as open and blocked dates, the service consumer is presented with a split screen having a first and second portion in the second interface providing the first calendar in a first portion of the split screen, and the third calendar is displayed in a second portion of the split screen.

2. The system of claim 1, wherein in an instance wherein the service consumer is also a service provider, blocked and available dates from a fourth calendar, generated by the mobile application, is merged with the third calendar and displayed in the second portion of the split screen.

3. The system of claim 1, wherein the first and second computerized communication devices include handheld devices such as smartphones and tablets.

4. The system of claim 1, wherein the service consumer selects at least one service provider from the list, views profile data and availability on the first calendar, and requests an appointment for a specified date and time that does not conflict with the third calendar.

5. The system of claim 4 wherein the service provider receives the request for the appointment and accepts the appointment, causing the mobile application to automatically update both the first and third calendars or reject the appointment.

6. The system of claim 3, wherein the mobile application accesses the third calendar locally on the second computerized communication device and suggests service providers from the list having availability dates and times that match availability dates and times of the first calendar.

7. The system of claim 1 wherein the mobile application enables direct communication between the service consumer and one or more providers selected from the list.

8. The system of claim 1 wherein the mobile application enables the service providers matching the search to send communications directly to the service consumer.

9. The system of claim 1 wherein the service provider sets specific time frames for specific services which are used as constraints in the first calendar displaying available dates and times offered, and when appointments are accepted from service consumers, a time frame is blocked as unavailable on both the first and second calendars.

10. A method for connecting professionals providing services with service consumers, provided by software stored on and executing from a data communications_network-connected server comprising the steps of:
(a) providing a first display on a first computerized communication device, the display having a first interface enabling a service provider to input services available via a first mobile computerized communication device at a first location of a service professional via a mobile application stored on and executing from said device, said mobile application associated and communicating with the software over the network, the server storing the input to a database accessible to the server;
(b) providing a second display on a second computerized communication device, the display having a second interface via the mobile application stored on and executing from a second mobile computerized communication device at a second location of a service consumer enabling the service consumer to input a service search function;
(c) providing a first calendar in the first interface enabling a service provider to enter blocked dates and times and available dates and times for providing services and a second calendar stored locally at the first computerized communication device, third party to the mobile application and providing a third calendar at the second interface enabling the service consumer to enter dates available for receiving services, and a fourth calendar stored locally at the second computerized communication device, third party to the mobile application, said first and third calendars stored in the database;
(d) performing a search request by the service consumer at the second interface, the service request including service type, date, time; and
(e) matching the search request to service providers by accessing available times and dates in the first calendar, as entered at the first interface and generating a list of selectable matched service providers to the second interface;
(f) dynamic switching is enabled by the mobile application between the first and second interface in each of the first and second displays enabling the professional to also function as a service consumer in the first display and the service consumer to also function as a service professional in the second display; and
(g) upon selection of a service provider by the service consumer, data from the second calendar is merged into the first calendar as open and blocked dates, the consumer is presented with a split screen having a first and second portion in the second interface providing the first calendar in a first portion of the split screen, and the third calendar is displayed in a second portion of the split screen.

11. The method of claim 10, wherein in an instance wherein the service consumer is also a service provider, blocked and available dates from a fourth calendar, generated by the mobile application, is merged with the third calendar and displayed in the second portion of the split screen.

12. The method of claim 10, wherein the mobile computerized communications devices include handheld devices such as smartphones and tablets.

13. The method of claim 10, wherein the service consumer selects at least one service provider from the list, views profile data and availability on the service provider's calendar, as provided by the server, and requests an appointment for a specified date and time that does not conflict with the third calendar.

14. The method of claim 13 wherein the service provider receives the appointment request and accepts the appointment, causing the mobile application to automatically update both the first and third calendars or rejects the appointment.

15. The method of claim 14, wherein the mobile application accesses the third calendar locally on the second computerized communication device and suggests service providers from the list having availability dates and times that match availability dates and times of the first calendar.

16. The method of claim 10 wherein the mobile application enables direct communication between the service consumer and one or more providers selected from the list.

17. The method of claim 10 wherein the mobile application enables the service providers matching the search to send communications directly to the service consumer.

18. The method of claim 15 wherein the service provider sets specific time frames for specific services which are used as constraints in a display of available times offered in the first calendar, and when appointments are accepted from service consumers, the specific time frames are blocked as unavailable on both the first and third calendars.
